(19) United States
(12) Patent Application Publication
(10) Pub. No.: US 2011/0027715 A1
(43) Pub. Date: Feb. 3, 2011

(54) DEVELOPER, IMAGE FORMING APPARATUS AND IMAGE FORMING METHOD

(75) Inventor: Mitsutoshi Watanabe, Shizuoka (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/845,940

(22) Filed: Jul. 29, 2010

Related U.S. Application Data
(60) Provisional application No. 61/229,631, filed on Jul. 29, 2009.

(51) Int. Cl. G03G 9/08; G03G 13/16; G03G 15/08

(52) U.S. Cl. 430/110.4; 430/125.3; 399/252

(57) ABSTRACT

A developer for forming an image on a transfer medium includes a toner having a volume average particle size of 3 to 8 μm, and a mixed carrier including a first carrier having a volume average particle size of 25 to 40 μm and conductivity that corresponds to a current value of 1.5 to 2.0 μA at application of 1000 V for 30 sec, and a second carrier having a volume average particle size of 35 to 60 μm larger than the first carrier and conductivity that corresponds to a current value of 2.0 to 4.0 μA larger than the first carrier at application of 1000 V for 30 sec.

### CROSS-REFERENCE TO RELATED APPLICATION

This application is based upon and claims the benefit of priority from the prior U.S. Patent Application 61/229,631 filed on Jul. 29, 2009, the entire contents of which are incorporated herein by reference.

### FIELD

Embodiments described herein relate generally to a developer, an image forming apparatus and an image forming method.

### BACKGROUND

In an image forming apparatus of an electrophotographic system, a toner image is formed on a surface of a photoreceptors as an image bearing member, and is transferred onto a transfer medium such as a sheet. With respect to the toner used at this time, reduction in particle size is advanced in accordance with a request for a high quality and high definition image from the market.

However, when the particle size of the toner is reduced, there is a problem that a charge amount per unit weight is increased and an image density is lowered. Besides, because of a decrease in surface area per particle, there arises a problem of background fog due to a decrease in a charge amount per particle.

### BRIEF DESCRIPTION OF THE DRAWINGS

The accompanying drawings, which are incorporated in and constitute a part of this specification, illustrates an embodiment of the invention and together with the description, serve to explain the principles of the invention.

FIG. 1 shows a structure of a carrier resistance measuring device of an embodiment of the invention;

FIG. 2 is a schematic structural view of an image forming apparatus of the embodiment of the invention; and

FIG. 3 is a table showing evaluation results of a developer of the embodiments of the invention

### DETAILED DESCRIPTION

Reference will now be made in detail to the present embodiment of the invention, an example of which is illustrated in the accompanying drawing.

A developer of an embodiment includes a toner having a volume average particle size of 3 to 8 μm, and a mixed carrier obtained by mixing a first carrier having a volume average particle size of 20 to 40 μm and conductivity that corresponds to a current value of 1.5 to 2.0 μA at application of 1000 V for 30 sec, and a second carrier having a volume average particle size of 35 to 60 μm larger than the first carrier and conductivity that corresponds to a current value of 2.0 to 6.0 μA larger than the first carrier at application of 1000 V for 30 sec.

The toner includes a coloring agent, a binder resin, a release agent and the like, and an external additive agent is added when necessary. The volume average particle size of such toner is 3 to 8 μm. When the volume average particle size is smaller than 3 μm, and when a charge amount which can be controlled by an electric field is applied to each toner particle, the charge amount per weight becomes excessively large, and it becomes difficult to obtain a desired development amount. Besides, when the volume average particle size is larger than 8 μm, reproducibility of a fine image and graininess is deteriorated. The volume average particle size is more preferably 4 to 6 μm.

As a carrier to charge such toner, a mixed carrier is used which includes a first carrier having a small particle size and a high resistance and a second carrier having a large particle size and a low resistance.

The volume average particle size of the first carrier is 20 to 40 μm. When the volume average particle size is smaller than 20 μm, since the magnetic force of one particle is small, the particle becomes liable to adhere to a photoreceptor. On the other hand, when the volume average particle size exceeds 40 μm, it becomes difficult to obtain a sufficient surface area. The volume average particle size is more preferably, 22 to 20 μm.

The volume average particle size of the second carrier is 35 to 60 μm. When the volume average particle size is smaller than 35 μm, there arises a problem of adherence of the particles. On the other hand, when the volume average particle size exceeds 60 μm, it affects in coverage of the toner and it becomes difficult to obtain sufficient charge to the toner. The volume average particle size is more preferably, 40 to 50 μm.

It is preferable that the difference in average particle size between the first carrier and the second carrier is 15 μm or more from the viewpoint of obtaining a desired development amount, background fog and adherence of the particles. Besides, it is preferable that the variation in particle size is small from the viewpoint of obtaining a desired development amount, background fog and adherence of the particles, and it is preferable that the standard deviation of a particle size distribution with respect to volume reference is 3.0 or less.

There are two peaks in the particle size distribution with respect to volume reference in the mixed carrier of the first carrier and the second carrier. The peak on the small particle size side exists in a range of 20 to 40 μm, and the peak on the large particle size side exists in a range of 35 to 60 μm. It is preferable that the difference in particle size between the two peaks is 15 μm or more.

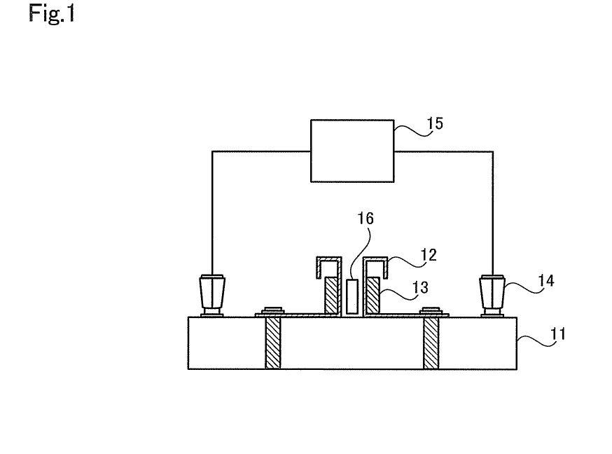

Besides, the first carrier has a high resistance value, and the second carrier has a low resistance value. The resistance value is defined by a value measured by a carrier resistance measuring device shown in FIG. 1.

As shown in FIG. 1, in the carrier resistance measuring device, a pair of face-to-face electrodes 12 and a pair of magnets 13 to sandwich these are disposed on a stage 11, and a face-to-face electrode type cell is constructed. Each of the face-to-face electrodes 12 is grounded, and is connected to an insulation resistance meter 15 at a terminal 14. A sample 16 of 0.2 g is put in the cell, a gap of the face-to-face electrodes 12 is set to 4 mm, a voltage is applied under a condition of 1000 V and 30 sec, and conductivity that corresponds to a current value is measured.

The current value of the first carrier measured in this way is 1.0 to 4.0 μA. When the current value is smaller than 1.5 μA, there arises a problem of reproducibility of a fine line, and when the current value exceeds 4.0 μA, there arises a problem of adherence of the particles. The current value is more preferably 1.5 to 2.0 μA.

Besides, the current value of the second carrier measured in the same way is 2.0 to 6.0 μA. When the current value is smaller than 2.0 μA, there arises a problem of reproducibility of a fine line, and when the current value exceeds 4.0 μA, there arises a problem of adherence of the particles. The current value is more preferably 2.0 to 4.0 μA.

In the mixed carrier of the first carrier and the second carrier, when particles are divided into particles having particle sizes smaller than the peak on the small particle size side in the particle size distribution with respect to volume reference, and particles having particle sizes larger than the peak on the large particle size side, the current values of the particles having the small particle sizes are 1.0 to 4.0 μA, and the current values of the particles having the large particle sizes are 2.0 to 6.0 μA.

As the first carrier and the second carrier, for example, magnetic particles of ferrite, magnetite, iron oxide or the like, or resin particles mixed with magnetic powder of those can be used, and a resin coat carrier in which a resin coat layer is formed on the surface of a magnetic particle is preferable.

The particle size of the first carrier and that of the second carrier can be controlled by suitably controlling the particle size of the magnetic particle as a core material. In the resin coat carrier, the resistance value can be controlled by the kind and thickness of the resin coat. For example, the resistance value can be controlled by changing the amount of addition of a conductor such as carbon.

In the developer including the toner and the mixed carrier of the first carrier and the second carrier, it is preferable that a coverage F:

F=¼·(dc/dt)·(pc/pt)/(wc/wt)

dc: volume average particle size of mixed carrier

dt: volume average particle size of toner

pc: true specific gravity of carrier

pt: true specific gravity of toner

wc: weight of carrier

wt: weight of toner

of the toner to the surface of the carrier is 15 to 50%.

When the coverage F of the toner is smaller than 15%, an image density is lowered since an amount of development runs short, and when the coverage exceeds 50%, background fog is increased. More preferably, the coverage is 20 to 40%.

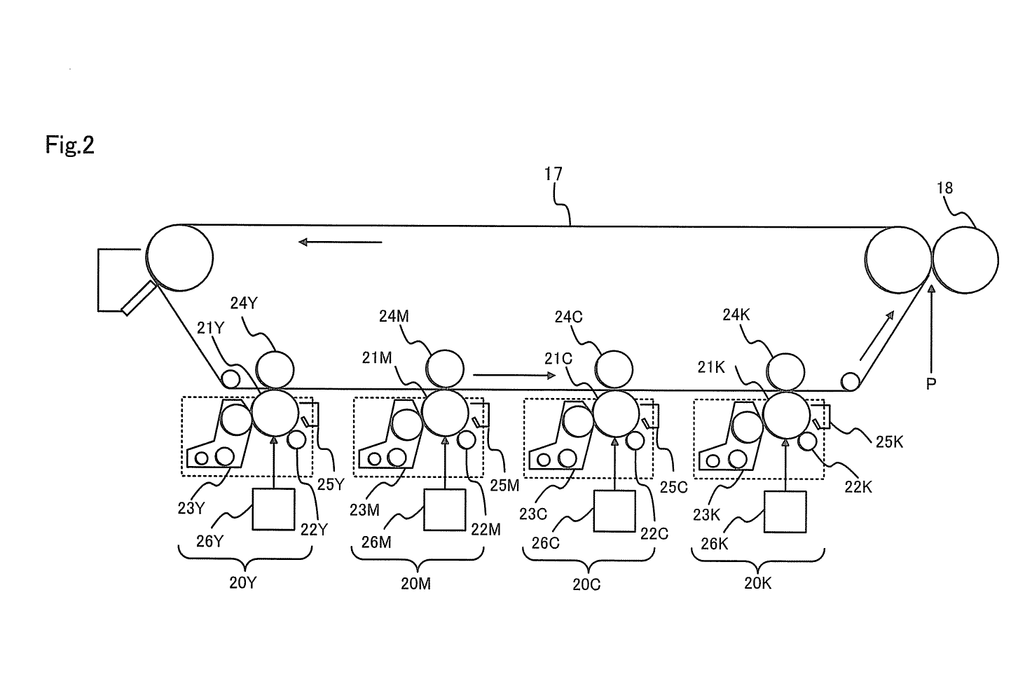

The developer including the toner and the mixed carrier as stated above is put in an image forming apparatus, and an image is formed on a transfer medium. Although the image forming apparatus is not limited, specifically, for example, a four-drum tandem color printer as shown in FIG. 2 can be preferably used.

As shown in FIG. 2, a secondary transfer roller 18 to transfer an image on an intermediate transfer belt 17 onto a transfer medium P, and image forming units 20_{Y}, 20_{M}, 20_{C} and 20_{K} are arranged along a conveyance direction (arrow direction) of the intermediate transfer belt 17.

The image forming units 20_{Y}, 20_{M}, 20_{C} and 20_{K} respectively include photoreceptors 21_{Y}, 21_{M}, 21_{C} and 21_{K} as image bearing members. Further, chargers 22_{Y}, 22_{M}, 22_{C} and 22_{K} as charging units, developing devices 23_{Y}, 23_{M}, 23_{C} and 23_{K} including developing rollers as developing members and containing developers including toner particles of respective colors of yellow, magenta, cyan and black and carrier particles, respectively, primary transfer rollers 24_{Y}, 24_{M}, 24_{C} and 24_{K} as transfer units, and cleaner units 25_{Y}, 25_{M}, 25_{C} and 25_{K} are provided around the respective photoreceptors. These are arranged along the rotation directions of the corresponding photoreceptors 21_{Y}, 21_{M}, 21_{C} and 21_{K}.

The respective primary transfer rollers 24_{Y}, 24_{M}, 24_{C} and 24_{K} are arranged inside the intermediate transfer belt 17, and pinch the intermediate transfer belt 17 between themselves and the corresponding photoreceptors 21_{Y}, 21_{M}, 21_{C} and 21_{K}. Exposure devices 26_{Y}, 26_{M}, 26_{C} and 26_{K} are arranged so that exposure points are respectively formed on the outer peripheral surfaces of the photoreceptors 21_{Y}, 21_{M}, 21_{C} and 21_{K} between the chargers 22_{Y}, 22_{M}, 22_{C} and 22_{K} and the developing devices 23_{Y}, 23_{M}, 23_{C} and 23_{K}. The secondary transfer roller 18 is arranged outside the intermediate transfer belt 17 so as to contact therewith.

In the image forming apparatus constructed as described above, first, a toner image is formed by the image forming unit 20_{Y}. In synchronization with the timing of the toner image formation in the image forming unit 20_{Y}, the same process is performed also in the image forming units 20_{M}, 20_{C} and 20_{K}. The toner images of magenta, cyan and black formed on the photoreceptors of the image forming units 20_{M}, 20_{C} and 20_{K} are successively primarily transferred onto the intermediate transfer belt 17.

The transfer medium P is conveyed from a cassette (not shown), and is sent to the intermediate transfer belt 17 by an aligning roller (not shown) in synchronization with the timing of the toner image on the intermediate transfer belt 17.

A bias (+) of a polarity reverse to the charging polarity of toner is applied to the secondary transfer roller 18 by a power source (not shown). As a result, the toner image on the intermediate transfer belt 17 is transferred onto the transfer medium P by a transfer electric field formed between the intermediate transfer belt 17 and the secondary transfer roller 18. A fixing unit (not shown) to fix the toner transferred on the transfer medium P is disposed, and a fixed image is obtained by causing the transfer medium P to pass through the fixing unit.

Here, although the description is made while using the example in which the image forming units are arranged in color order of yellow, magenta, cyan and black, the color order is not limited.

Hereinafter, examples will be described.

### Preparation of Developer

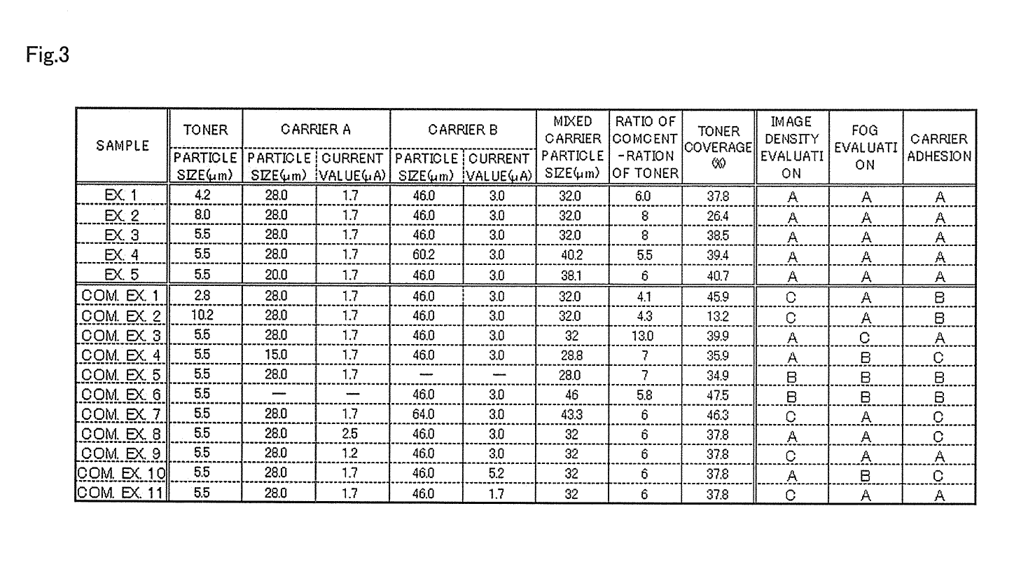

As shown in FIG. 3, as a core material, spherical ferrite (Mn—Mg based ferrite) having volume average particle sizes of 5 μm for the first carrier and 43 μm for the second carrier are used. As a coat layer, for example, silicone based resin is used, is applied to the surface of the core material and is heated, and the coat layer is formed on the surface of the core material.

Here, the addition amount of carbon is changed to 0 to 1 wt %, so that the resistance value of the carrier is controlled. Besides, the coating speed of the coat layer is adjusted, and the coat layer thickness is made 10 to 100 nm, so that the resistance value of the carrier is controlled. The carrier resistance measuring device of FIG. 1 is used for the measurement of the resistance value of the carrier. Two kinds of carriers A and B different from each other in particle size and resistance value (current value) obtained in this way are mixed so that mixed carriers are prepared.

Besides, as a toner, for example, a pulverized toner having a volume average particle size of 6 to 7 μm and containing polyester based resin as its main ingredient is used, and a toner coverage F:

F=¼·(dc/dt)·(pc/pt)/(wc/wt)

dc: volume average particle size of mixed carrier

dt: volume average particle size of toner

pc: true specific gravity of carrier

pt: true specific gravity of toner

wc: weight of carrier

wt: weight of toner

is controlled by the volume average particle size, mixture ratio (weight ratio) and the like of the toner and the carrier.

The obtained mixed carrier and the toner are mixed so that the developer is obtained. Table of FIG. 3 shows the particle sizes and resistance values of the carriers and the toner coverages in the developers of examples 1 to 16 and comparative examples 1 to 10.

### Evaluation of Developer

The developing agents prepared as described above are evaluated as described below. The respective evaluations are performed using a multi function peripheral e-STUDIO 103500C made by Toshiba and under a test environment adjusted to a temperature of 20 to 25° C. and a humidity of 40 to 60%. The respective evaluations are performed after 150,000 sheets are used in which A4 charts are printed with black toner at a print ratio of 8%.

### Evaluation of Image Density

After 150,000 sheets are used, a solidly shaded image is outputted. The density of the outputted image is measured using Macbeth 191, and a case where the measurement value is 1.3 or more is evaluated as A, a case where it is not less than 1.0 and less than 1.3 is evaluated as B, and a case where it is less than 1.0 is evaluated as C.

### Fog Evaluation

After 150,000 sheets are used, a fogging density on a sheet of white paper copy is measured by a photovolt, and a case where the fogging density is less than 2% is evaluated as A, a case where it is not less than 2% and less than 4% is evaluated as B, and a case where it is not less than 4% is evaluated as C.

These evaluations are shown in Table of FIG. 3. As shown in FIG. 3, when the particle size of the toner, and the particle size and current value of the carrier A having small particle size and high resistance, and the carrier B having large particle size and low resistance are within specified ranges, the excellent characteristic can be obtained. Besides, when the toner coverage is 15 to 50% or it is 20 to 40%, characteristic of development becomes excellent.

While certain embodiments have been described, these embodiments have been presented by way of example only, and are not intended to limit the scope of the inventions. Indeed, the novel embodiments described herein may be embodied in a variety of other forms; furthermore, various omission, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A developer comprising:
a toner having a volume average particle size of 3 to 8 μm; and
a mixed carrier including a first carrier having a volume average particle size of 20 to 40 μm and conductivity that corresponds to a current value of 1.5 to 2.0 μA at application of 1000 V for 30 sec, and a second carrier having a volume average particle size of 35 to 60 μm larger than the first carrier and conductivity that corresponds to a current value of 2.0 to 6.0 μA larger than the first carrier at application of 1000 V for 30 sec.

2. The developer of claim 1, wherein
a coverage F:
F=¼·(dc/dt)·(pc/pt)/(wc/wt)
dc: volume average particle size of mixed carrier
dt: volume average particle size of toner
pc: true specific gravity of carrier
pt: true specific gravity of toner
wc: weight of carrier
wt: weight of toner
of the toner to a surface of the mixed carrier is 15 to 50%.

3. The developer of claim 2, wherein the coverage F is 20 to 40%.

4. The developer of claim 1, wherein in a particle size distribution of the mixed carrier with respect to volume reference, a first peak is 20 to 40 μm, and a second peak on a large particle size side of the first peak is 35 to 60 μm.

5. The developer of claim 4, wherein a difference between a particle size of the first peak and a particle size of the second peak is 15 μm or more.

6. The developer of claim 1, wherein the mixed carrier is a carrier in which a core material is coated with a resin.

7. The developer of claim 6, wherein the first carrier and the second carrier are different from each other in at least one of a kind, a thickness and an additive of the resin.

8. An image forming apparatus comprising:
an image carrier on which an electrostatic latent image is formed; and
a developing device to supply the image carrier with a developer including a toner having a volume average particle size of 3 to 8 μm, and a mixed carrier including a first carrier having a volume average particle size of 20 to 40 μm and conductivity that corresponds to a current value of 1.5 to 2.0 μA at application of 1000 V for 30 sec, and a second carrier having a volume average particle size of 35 to 60 μm larger than the first carrier and conductivity that corresponds to a current value of 2.0 to 6.0 μA larger than the first carrier at application of 1000 V for 30 sec.

9. The apparatus of claim 8, wherein
a coverage F:
F=¼·(dc/dt)·(pc/pt)/(wc/wt)
dc: volume average particle size of mixed carrier
dt: volume average particle size of toner
pc: true specific gravity of carrier
pt: true specific gravity of toner
wc: weight of carrier
wt: weight of toner
of the toner to a surface of the mixed carrier is 15 to 50%.

10. The apparatus of claim 9, wherein the coverage F is 20 to 40%.

11. The apparatus of claim 8, wherein in a particle size distribution of the mixed carrier with respect to volume reference, a first peak is 20 to 40 μm, and a second peak on a large particle size side of the first peak is 35 to 60 μm.

12. The apparatus of claim 11, wherein a difference between a particle size of the first peak and a particle size of the second peak is 15 μm or more.

13. The apparatus of claim 8, wherein the first carrier and the second carrier are carriers in each of which a core material is coated with a resin.

14. The apparatus of claim 13, wherein the first carrier and the second carrier are different from each other in at least one of a kind, a thickness and an additive of the resin.

15. An image forming method comprising:
forming an electrostatic latent image on an image carrier;
forming an image on the image carrier by developing the electrostatic latent image with a developer which includes a toner having a volume average particle size of 3 to 8 μm, and a mixed carrier including a first carrier having a volume average particle size of 20 to 40 μm and conductivity that corresponds to a current value of 1.5 to 2.0 μA at application of 1000 V for 30 sec, and a second carrier having a volume average particle size of 35 to 60 μm larger than the first carrier and conductivity that corresponds to a current value of 2.0 to 6.0 μA larger than the first carrier at application of 1000 V for 30 sec; and
transferring the image to a transfer medium.

16. The method of claim 15, wherein
a coverage F:
F=¼·(dc/dt)·(pc/pt)/(wc/wt)
dc: volume average particle size of mixed carrier
dt: volume average particle size of toner
pc: true specific gravity of carrier
pt: true specific gravity of toner
wc: weight of carrier
wt: weight of toner
of the toner to a surface of the mixed carrier is 15 to 50%.

17. The method of claim 16, wherein the coverage F is 20 to 40%.

18. The method of claim 15, wherein in a particle size distribution of the mixed carrier with respect to volume reference, a first peak is 20 to 40 μm, and a second peak on a large particle size side of the first peak is 35 to 60 μm.

19. The method of claim 18, wherein a difference between a particle size of the first peak and a particle size of the second peak is 15 μm or more.

20. The method of claim 15, wherein the first carrier and the second carrier are carriers in each of which a core material is coated with a resin.
